(19) United States
(12) Patent Application Publication
(10) Pub. No.: US 2008/0121387 A1
(43) Pub. Date: May 29, 2008

(54) Heat Exchanger and Method of Producing the Same

(75) Inventors: Mitsunori Taniguchi, Shiga (JP); Osao Kido, Kyoto (JP); Kiyoshi Kinoshita, Shiga (JP); Takashi Okutani, Shiga (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/720,135

(22) PCT Filed: Nov. 18, 2005
(86) PCT No.: PCT/JP05/21228

§ 371 Date: May 24, 2007

(30) Foreign Application Priority Data
Nov. 30, 2004 (JP) 2004-345389
Jan. 28, 2005 (JP) 2005-020747

(51) Int. Cl. F28F 9/02; B23P 15/26

(52) U.S. Cl. 165/175; 29/890.045

(57) ABSTRACT

A heat exchanger is formed by connecting tube-group blocks along a tube axis, where each one of tube-group blocks includes a plurality of substrates having a large number of through holes, which communicate with insides of a plurality of tubes placed between the substrates. A length of the tubes can be shortened so that the tube-group block can be formed within a predetermined size. The substrates and the tubes can be formed by injection molding or die-casting simultaneously with ease, so that the manufacturing steps of inserting the tubes and bonding the substrates can be eliminated. The heat exchanger can be available at a lower cost while it maintains excellent heat exchanging performance.

### TECHNICAL FIELD

The present invention relates to a heat exchanger to be used in a cooling system, heat dissipation system, and heating system. More particularly, it relates to a heat exchanger between liquid and gas, which exchanger is employed in a system requiring compactness such as an information-processing device. The present invention also relates to a method of producing the same heat exchanger.

### BACKGROUND ART

A conventional heat exchanger of this kind is generally formed of tubes and fins, and this exchanger has been downsized by using tubes arranged in a higher density, i.e. tubes having a smaller diameter are arranged at smaller intervals. Unexamined Japanese Patent Publication No. 2001-116481 (cited reference 1) discloses an example of the downsized heat exchanger that employs tubes measuring as small as approx. 0.5 mm in outer diameter.

FIG. 29 shows a front view of the conventional heat exchanger disclosed in cited reference 1.

As shown in FIG. 29, the conventional heat exchanger comprises inlet tank 1 and outlet tank 2 placed oppositely to each other at a given interval in between, a plurality of tubes 3 of which cross section shows an annular shape, and core section 4 placed outside of the tubes 3. Inner fluid running through tubes 3 is generally water or anti-freeze solution, and outer fluid running through core section 4 is generally air. The inner fluid and the outer fluid run through tubes 3 and core section 4 respectively, so that the heat is exchanged.

Tubes 3 are arranged in check pattern, and the outer diameter of each one of tubes 3 falls within the range not less than 0.2 mm and not greater than 0.8 mm. An interval between tubes 3 adjacent to each other is set such that the interval divided by the outer diameter of tube 3 falls within the range not less than 0.5 and not greater than 3.5. The foregoing structure allows substantially increasing an amount of exchanged heat with respect to the power used for this operation.

Cited reference 1 does not disclose specifically the structural elements and a manufacturing method of the foregoing conventional heat exchanger. In general, a number of small-diameter tubes 3, inlet tank 1 and outlet tank 2 are prepared, and numerous fine and round holes have been pierced in predetermined faces of tanks 1 and 2. Both ends of each one of tubes 3 are inserted into the holes of tank 1 and tank 2, and the inserted sections of tubes 3 are welded and fixed to tank 1 and tank 2.

However, improvement of the heat exchange performance of the foregoing heat exchanger will cost a lot, and yet, the improvement will lower the reliability of leakage. Because a long-length and small-diameter tube 3 is so expensive, the foregoing structure needs a step of piercing fine and round holes 3 at fine intervals for receiving tubes 3 on tank 1 and tank 2, and it also needs a step of inserting numerous tubes 3 into both of tank 1 and tank 2 before fixing them to tanks 1 and 2. These steps require difficult work.

### DISCLOSURE OF INVENTION

The present invention addresses the problems discussed above, and aims to provide a heat exchanger comprises the following elements:
a plurality of substrates having a large number of through holes; and
tube-group blocks including a plurality of tubes whose insides communicate with the though holes, and which tube-group blocks are placed between the substrates and coupled to each other along the tube axis.

The length of the tube-group blocks can be shortened so that the tube-group blocks can be connected to each other within a predetermined size, and the substrates together with the tubes can be manufactured with ease simultaneously by injection molding or die-casting. The steps of inserting and fixing the tubes can be thus eliminated, so that the heat exchanger can be available at a lower cost.

The heat exchanger of the present invention can adopt the following structure as well: The tube-group blocks formed of plurality of tubes whose insides communicate with a large number of through holes provided to the substrates, and the tubes generally rise upright from the surface of the substrates, and the tube-group blocks are overlaid one after another via a mixer.

This structure allows the inner fluid to be mixed in the mixer placed at the outlet of the tube-group block, even if a part of the tube-group block is clogged with something, so that the inner fluid flows to the next tube-group block. As a result, this structure can limit a non-fluid area of the inner fluid due to the clogging to only one tube-group block.

### BRIEF DESCRIPTION OF DRAWINGS

FIG. 1 shows a front view of a heat exchanger in accordance with a first embodiment of the present invention.

FIG. 2 shows a lateral view of the heat exchanger in accordance with the first embodiment.

FIG. 3 shows a sectional view of the heat exchanger cut along line A-A in FIG. 1.

FIG. 4 shows a sectional view of the heat exchanger cut along line B-B in FIG. 2.

FIG. 5 shows a perspective view of tube-group block of the heat exchanger in accordance with the first embodiment.

FIG. 6 shows a front view of the tube-group block of the heat exchanger in accordance with the first embodiment.

FIG. 7 shows a top view of the tube-group block of the heat exchanger in accordance with the first embodiment.

FIG. 8 shows a front view of a heat exchanger in accordance with a second embodiment of the present invention.

FIG. 9 shows a lateral view of the heat exchanger in accordance with the second embodiment.

FIG. 10 shows a sectional view of the heat exchanger cut along line C-C in FIG. 8.

FIG. 11 shows a sectional view of the heat exchanger cut along line D-D in FIG. 9.

FIG. 12 shows a perspective view of tube-group blocks of the heat exchanger in accordance with the second embodiment.

FIG. 13 shows a front view of the tube-group block of the heat exchanger in accordance with the second embodiment.

FIG. 14 shows a top view of the tube-group block of the heat exchanger in accordance with the second embodiment.

FIG. 15 shows a front view of a heat exchanger in accordance with a third embodiment of the present invention.

FIG. 16 shows a lateral view of the heat exchanger in accordance with the third embodiment.

FIG. 17 shows a sectional view of the heat exchanger cut along line A-A in FIG. 16.

FIG. 18 shows a sectional view of the heat exchanger cut along line B-B in FIG. 16.

FIG. 19 shows a perspective view of tube-group block of the heat exchanger in accordance with the third embodiment.

FIG. 20 shows a front view of the tube-group block of the heat exchanger shown in FIG. 15.

FIG. 21 shows a top view of the tube-group block of the heat exchanger shown in FIG. 15.

FIG. 22 shows a front view of a heat exchanger in accordance with a fourth embodiment of the present invention.

FIG. 23 shows a lateral view of the heat exchanger in accordance with the fourth embodiment.

FIG. 24 shows a sectional view of the heat exchanger cut along line C-C in FIG. 23.

FIG. 25 shows a sectional view of the heat exchanger cut along line D-D in FIG. 23.

FIG. 26 shows a perspective view of tube-group block of the heat exchanger shown in FIG. 22.

FIG. 27 shows a front view of the tube-group block of the heat exchanger shown in FIG. 22.

FIG. 28 shows a lateral view of the tube-group block of the heat exchanger shown in FIG. 22.

FIG. 29 shows a front view of a conventional heat exchanger.

### DESCRIPTION OF REFERENCE MARKS

10, 10a, 10b, 10c, 10d, 10e, 110 tube

20, 120 substrate

30, 130 tube-group block

40, 40a, 40b, 40c tube-group block

140, 140a, 140b, 140c tube-group block

50, 150 inlet header

60, 160 outlet header

70, 70a, 70b, 170, 170a, 170b mixer

80, 180 spacer

90, 190 periphery

115, 115a, 115b, 115c, 115d, 115e flow path

210 inner fluid

220 outer fluid

100, 200, 300, 400 heat exchanger

### DESCRIPTION OF PREFERRED EMBODIMENTS

The present invention addresses the problems discussed above, and aims to provide a heat exchanger comprises the following elements:
a plurality of substrates having a large number of through holes; and
tube-group blocks including a plurality of tubes whose insides communicate with the through holes, which tube-group blocks are placed between the substrates and are coupled to each other along the tube axis.

The length of the tube-group blocks can be shortened so that the tube-group blocks can be connected to each other within a predetermined size, and the substrates together with the tubes can be manufactured with ease simultaneously by injection molding or die-casting. The steps of inserting and fixing the tubes can be thus eliminated, so that the heat exchanger can be available at a lower cost.

The heat exchanger of the present invention can have the following structure as well: the peripheries of the substrates adjacent to each other are coupled for connecting the tube-group blocks. This structure allows reducing the number of steps because of coupling together the peripheries which can be handled with ease from the outside when the tube-group blocks are connected to each other, so that boding reliability can be improved, and the heat exchanger can be available at a lower cost.

The heat exchanger of the present invention can have the following structure as well: Each one of the tubes is a multi-hole tube that includes a plurality of flow paths. This structure allows reducing the number of tubes without reducing the number of flow paths, so that the heat exchanger can be manufactured with ease and obtainable at a lower cost.

The heat exchanger of the present invention can have the following structure as well: The peripheries of the substrates are bonded together directly for connecting the tube-group blocks. This structure prevents the tubes from being clogged with brazing material supposed to be eluted, thereby reducing defectives substantially, and the heat exchanger can be available at a lower cost.

The heat exchanger of the present invention can have the following structure as well: The peripheries of the substrates are welded together. This structure prevents the tubes from being clogged with brazing material supposed to be eluted because the substrates per se are melted for bonding themselves together.

The heat exchanger of the present invention is subdivided along the flow of inner fluid, so that if a part of some tube-group block is clogged, a non-fluid area can be limited to only one block including the clogged tube. This structure thus can prevent a substantial reduction in heat exchanging amount.

The heat exchanger of the present invention can have the following structure as well: The mixer can be formed of the rear face of the substrate and a spacer mounted to the rear face in part. The spacer allows determining the height of the mixer with ease, so that the number of manufacturing steps can be reduced, and the heat exchanger can be available at a lower cost.

The heat exchanger of the present invention can have the following structure as well: The mixer can be formed of the rear face of the substrate and a spacer placed on the periphery of the substrate. The spacer can form a lateral wall of the mixer, so that a dedicated lateral wall is not needed. The heat exchanger can be thus available at a lower cost.

The heat exchanger of the present invention can have the following structure as well: The multi-hole tube has a cross section showing a flat shape, and the flow paths inside the tube are arranged along the longitudinal direction of the flat shape. The multi-hole tubes are arranged on the substrate at intervals wide enough for the tubes to be placed in parallel with the longitudinal direction. This structure allows reducing a width of flow paths for the outer fluid, and inviting a greater wind speed, so that the following advantages can be expected: increasing a heat transfer rate between the outer fluid and the tubes, and increasing a heat exchanging amount, this increment can compensate the lost amount due to the clogging in some of the tubes, so that substantial reduction in heat exchanging amount can be prevented.

The heat exchanger of the present invention can have the following structure as well: The tube groups, the substrates and the spacer are unitarily molded, thereby eliminating the steps of bonding these elements together. This reduction in the number of steps allows the heat exchanger to be available at a lower cost.

The heat exchanger of the present invention can have the following structure as well: The tube-group blocks are bonded together directly, which prevents the flow paths of the inner fluid from being clogged with brazing material. This structure thus reduces the number of defectives, so that the heat exchanger can be available at a lower cost.

The heat exchanger of the present invention can have the following structure as well: The tube-group blocks can be bonded to each other by diffusion welding. This structure does not melt the material of the substrates per se, thereby further reducing the clogging of the flow paths where the inner fluid runs. The number of defectives thus can be further reduced, and the heat exchanger can be available at a lower cost.

The heat exchanger of the present invention can have the following structure as well: The tube-group blocks can be bonded to each other by ultrasonic bonding. This structure does not melt the material of the substrates per se, thereby further reducing the clogging of the flow paths where the inner fluid runs. The number of defectives thus can be further reduced, and the heat exchanger can be available at a lower cost.

The heat exchanger of the present invention can have the following structure as well: At least one of the tube-group blocks or the spacer can be made of resin material. Use of inexpensive material, i.e. resin material, can reduce the direct material cost, so that the heat exchanger can be available at a lower cost.

The heat exchanger of the present invention can have the following structure as well: The tube-group blocks and the spacer can be made of resin material of high fluidity and low-viscosity. Use of this material allows the injection molding method to supply the resin as deep as up to the ends of fine tubes. The number of defectives thus can be reduced, so that the heat exchanger can be available at a lower cost.

The heat exchanger of the present invention can have the following structure as well: The tube-group blocks and the spacer can be made of resin material of low water vapor permeability. When water or antifreeze solution is used as the inner fluid, use of this material allows reducing an amount of the inner fluid permeated from the heat exchanger, so that the tubes can work with a thinner wall, and then the heat exchanger can be available at a lower cost.

The heat exchanger of the present invention can have the following structure as well: The tube-group blocks and the spacer are made of polypropylene (PP) or polyethylene terephthalate (PET). Use of these materials allows supplying resin as deep as up to the ends of the tubes, and reducing the number of defectives, and yet; the tubes can work with a thinner wall. The heat exchanger can be thus available at a lower cost.

The heat exchanger of the present invention is specifically described in the following exemplary embodiments.

### EXEMPLARY EMBODIMENT 1

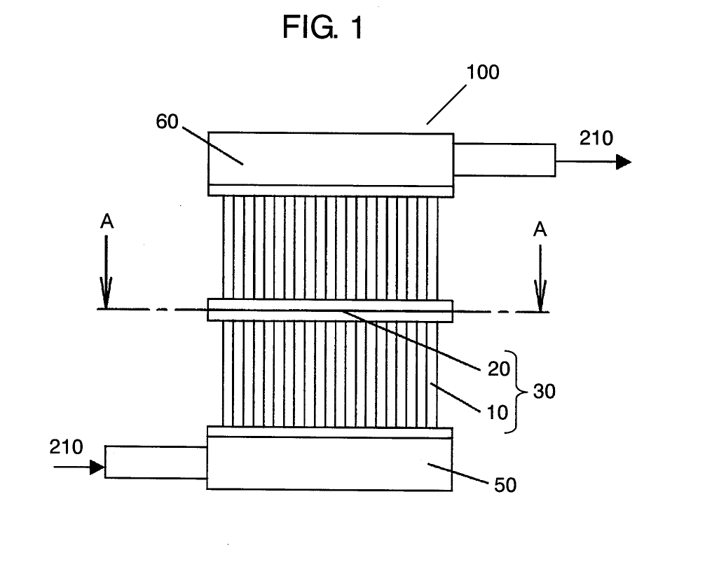

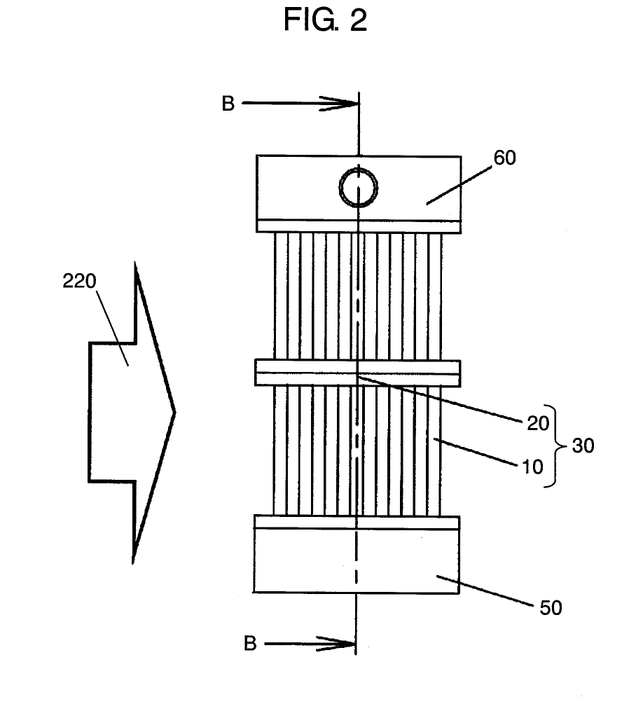

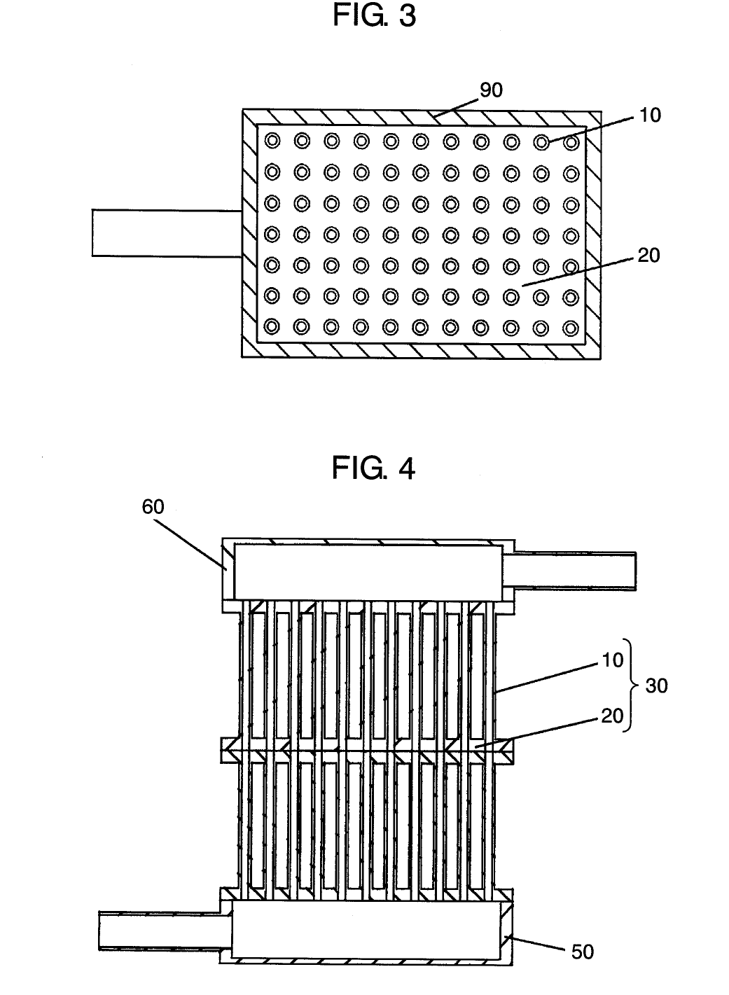

FIG. 1 shows a front view of a heat exchanger in accordance with the first embodiment of the present invention. FIG. 2 shows a lateral view of the heat exchanger, and FIG. 3 shows a sectional view cut along line A-A in FIG. 1, and FIG. 4 shows a sectional view cut along line B-B in FIG. 2.

As shown in FIG. 1-FIG. 4, heat exchanger 100 in accordance with the first embodiment includes tube-group blocks 30 formed of tubes 10 and substrates 20. Two tube-group blocks 30 are layered by connecting tubes 10 along the tube axis at peripheries 90 of substrates 20. Inlet header 50 and outlet header 60 are placed on the lower end and the upper end of layered blocks 30.

Each one of tubes 10 forms a cylindrical tube and includes one flow path through which inner fluid runs. Tube 10 is not necessarily a cylindrical one, e.g. it can be a tube of which cross section shapes like a rectangle, polygon or ellipse. Peripheries 90 of substrates 20 are connected to each other directly without using brazing material or adhesive. The connection is done by welding, ultrasonic bonding, or diffusion welding. This direct connection of peripheries 90 prevents tubes 10 from being clogged with the brazing material or the adhesive supposed to be eluted.

This first embodiment uses the diffusion welding, which applies pressure and heat, not high enough for the material of the substrates to be melted, to the elements simultaneously, thereby generating atomic diffusion (interdiffusion) phenomenon, and the bonding is done by using atomic bond. This method eliminates the elution of the material, so that tube 10 can be free from being clogged. Use of the diffusion welding, which does not need the brazing material, suppresses defectives such as clogging of tube 10 with the brazing material, so that heat exchanger 100 can be available at a lower cost.

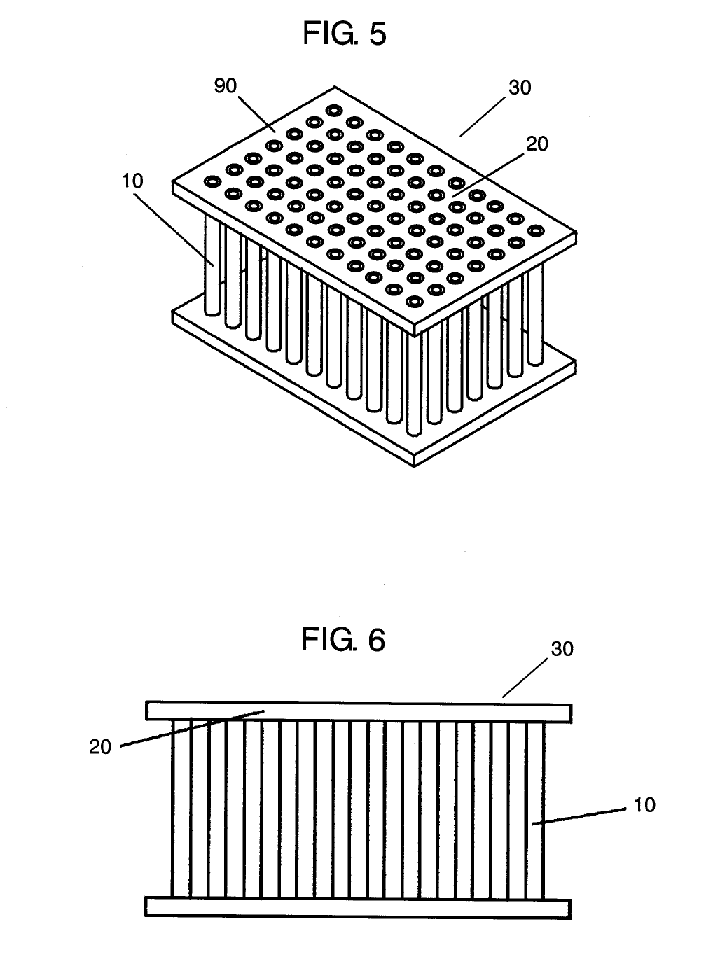

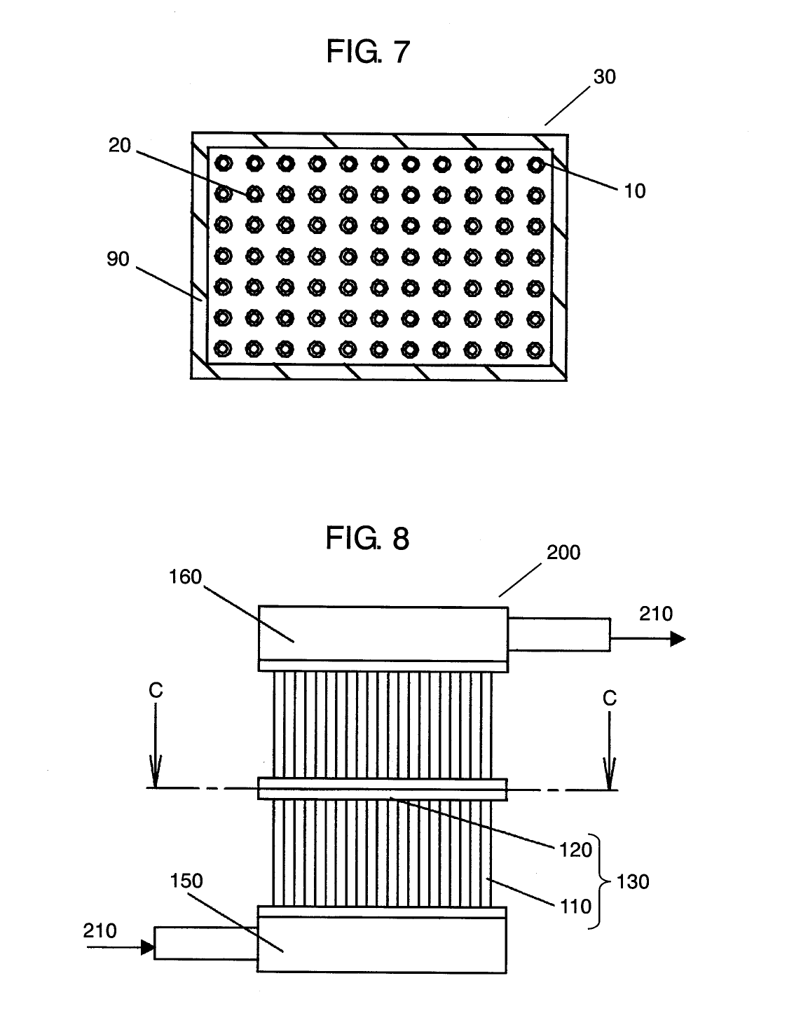

FIG. 5-FIG. 7 illustrate tube-group block 30 of heat exchanger 100. FIG. 5 shows a perspective view of tube-group block 30, FIG. 6 shows a front view of block 30, and FIG. 7 shows a top view of block 30.

Tube-group block 30 is unitarily formed of tubes 10 and substrates 20 by injection molding. Block 30 is preferably made of resin which is easy to mold and inexpensive. Since tube 10 has a small diameter and a large number of tubes 10 are used, tube-group block 30 forms a complicated shape. The resin material thus preferably has a low viscosity and a high fluidity in molding, because the resin should be supplied as deep as up to the respective ends of block 30. These properties of the resin are needed for the injection molding among others. Use of such resin material allows reducing the number of defectives, and heat exchanger 100 can be thus available at a lower cost.

When water or antifreeze solution is used as the inner fluid, use of resin material having low water vapor-permeability allows the wall of tube 10 to be thin because the inner fluid hardly permeates through the resin. Thus the material cost can be lowered, and heat exchanger 100 can be available at a lower cost.

The resin material is desirably polypropylene (PP) or polyethylene terephthalate (PET), both of which have low water vapor permeability and inexpensive.

TABLE 1

| | material | | |
|---|---|---|---|
| | | Polyethylene | Acrylonitrile- |
| | Polypropylene | terephthalate | butadiene- |
| properties | (PP) | (PET) | Styrene(ABS) |
| Melt-flow rate: | 60 | 50 | 22 |
| g/10 min | | | |
| Filling factor | 100 | 100 | 10 |
| at molding | | | |
| (vol %) | | | |
| Steam permeability: | 1.5 | 5.3 | 18 |
| Thickness: 0.1 mm | | | |
| (g/m² · day) | | | |
| Thickness(mm) | 0.15 | 0.53 | 1.8 |
| invites the water | | | |
| vapor permeability of | | | |
| 1 g/m² · day | | | |

As table 1 tells, PP or PET has a greater melt-flow rate, which indicates a viscosity, than that of ABS, so that PP or PET has higher fluidity. PP or PET can be thus filled well into a mold when the injection molding is carried out. PP or PET has low water vapor permeability, so that a thinner wall than the case where ABS is used can be used.

Tubes 10 are arranged in check pattern in this embodiment; however it can be arranged in zigzag pattern.

The movement and operation of heat exchanger 100 thus constructed are demonstrated hereinafter. Inner fluid 210 flows into inlet header 50, and separates into respective tubes 10, then passes through tube-group blocks 30 to the outside of heat exchanger 100 via outlet header 60. Outer fluid 220 moves outside respective tubes 10, i.e. between each one of tubes 10, so that heat is exchanged between inner fluid 210 and outer fluid 220 via tubes 10. In this embodiment, tube-group blocks 30 are overlaid in two layers; however, the number of layers can be more than two.

In this first embodiment, the length of tubes 10 can be shortened so that tube-group blocks 30 can be connected together within a given size. Substrates 20 and tubes 10 can be manufactured simultaneously with ease by injection molding or die-casting. This manufacturing method can eliminate the steps of inserting and fixing tubes 10, so that heat exchanger 100 can be available at a lower cost.

In this embodiment, peripheries 90 of substrates 20 are bonded to each other. When tube-group blocks 30 are coupled together, peripheries 90 easy to be handled from the outside are bonded together, so that the bonding reliability improves as well as the number of steps decreases. Heat exchanger 100 can be thus available at a lower cost.

Since tube-group blocks 30 are made of inexpensive resin material, heat exchanger 100 can be available at a lower cost.

Peripheries 90 of substrates 20 can be bonded directly to each other by the diffusion welding method, which does not need brazing material or adhesive and allows bonding the substrates free from being melted. As a result, the flow path in each one of tubes 10 is not clogged, and the number of defectives can be substantially reduced. Heat exchanger 100 is thus obtainable at a lower cost.

### EXEMPLARY EMBODIMENT 2

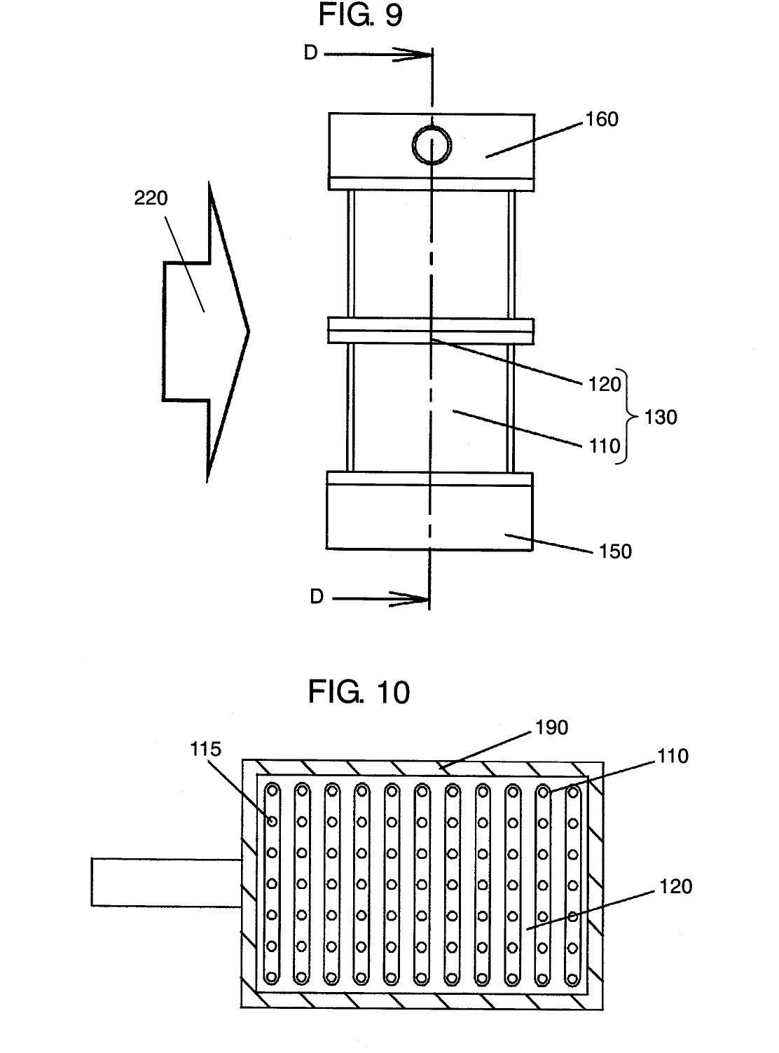

FIG. 8 shows a front view of a heat exchanger in accordance with the second embodiment of the present invention. FIG. 9 shows a lateral view of the heat exchanger, FIG. 10 shows a sectional view cut along line C-C in FIG. 8, and FIG. 11 shows a sectional view cut along line D-D in FIG. 9.

In FIG. 8-FIG. 11, heat exchanger 200 includes tube-group blocks 130 formed of tubes 110 and substrates 120. Peripheries 190 of substrates 120 are bonded together so that blocks 130 are coupled to each other in two layers along the axial direction of tubes 130, and inlet header 150 and outlet header 160 are placed on the lower and the upper ends of the two layers respectively.

In this second embodiment, each one of tubes 110 has a flat sectional view and includes a plurality of flow paths 115 arranged along the long side of the flat shape. Tubes 110 are arranged on substrates 120 such that they are in parallel with the long side respectively at given intervals. Peripheries 190 of substrates 120 are bonded together directly without using brazing material or adhesive. Welding, ultrasonic bonding, or diffusion welding can be employed as this direct bonding method. Direct bonding of peripheries 190 to each other of substrates 120 eliminates the brazing material or the adhesive supposed to be eluted, so that tubes 110 are not clogged with these materials.

This second embodiment employs the diffusion welding, which applies pressure and heat, not high enough for the material of the substrate to be melted, to the substrates simultaneously, thereby generating atomic diffusion (interdiffusion) phenomenon, and the bonding is done by using atomic bond. This method eliminates the elution of the substrates, so that tube 110 can be free from being clogged. Use of the diffusion welding, which does not need the brazing material, suppresses defectives such as clogging of tube 110 with the brazing material, so that heat exchanger 200 can be available at a lower cost.

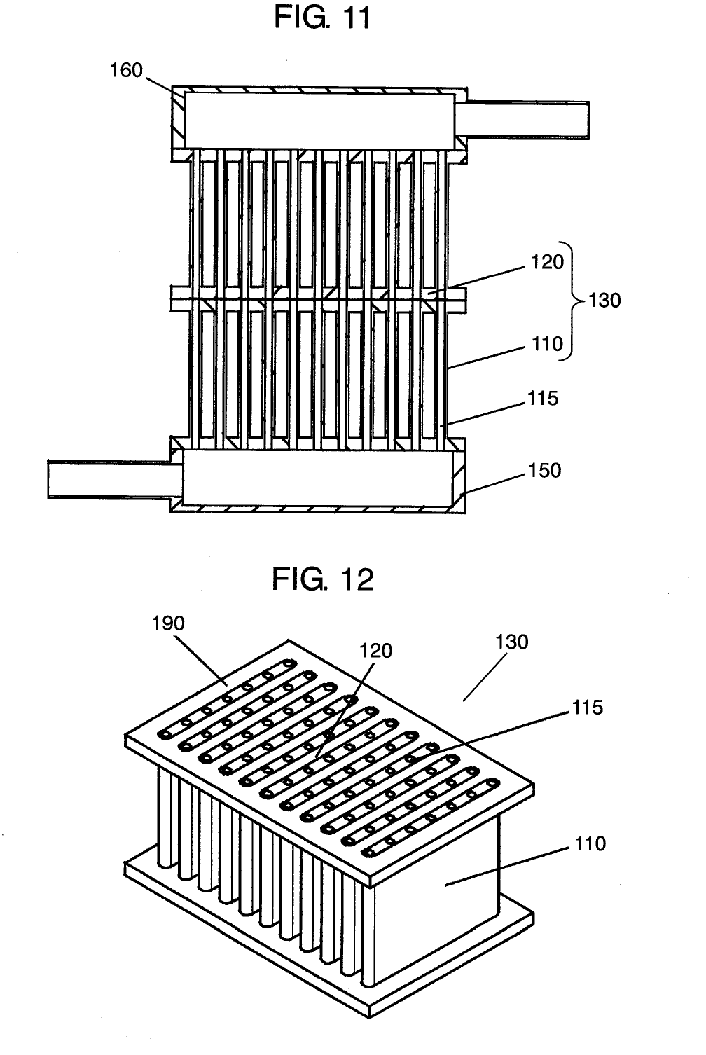

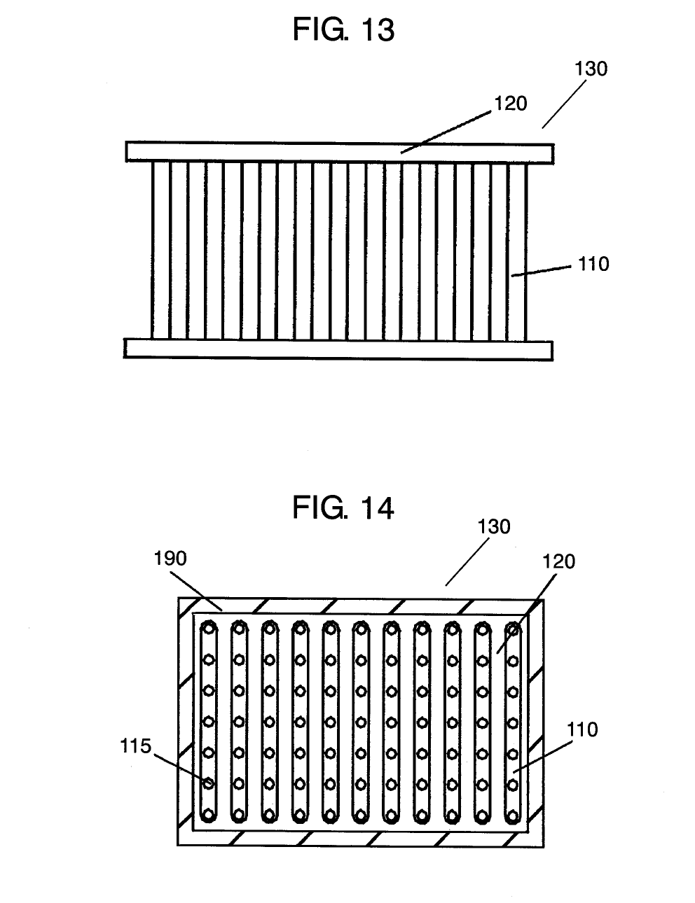

FIG. 12-FIG. 14 illustrate tube-group block 130 of heat exchanger 200. FIG. 12 shows a perspective view of tube-group block 130 in accordance with the second embodiment, FIG. 13 shows a front view of block 130, and FIG. 14 shows a top view of block 130.

Tube-group block 130 is unitarily formed of tubes 110 and substrates 120 by injection molding. Block 130 is preferably made of resin which is easy to mold and inexpensive, so that the number of defectives can be reduced and heat exchanger 200 can be available at a lower cost.

When water or antifreeze solution is used as the inner fluid, use of resin material having low water vapor-permeability allows tube 110 to work with a thin wall because the inner fluid hardly permeates through the resin. Thus the material cost can be lowered, and heat exchanger 200 can be available at a lower cost. The resin material is desirably polypropylene (PP) or polyethylene terephthalate (PET), both of which have low water vapor permeability and inexpensive.

The movement and operation of heat exchanger 200 thus constructed are demonstrated hereinafter. Inner fluid 210 flows into inlet header 150, and separates into respective tubes 110, then passes through tube-group blocks 130 to the outside of heat exchanger 200 via outlet header 160. Outer fluid 220 moves outside respective tubes 110, i.e. between each one of tubes 110, so that heat is exchanged between inner fluid 210 and outer fluid 220 via tubes 110. In this embodiment, tube-group blocks 130 are overlaid in two layers; however, the number of layers can be more than two.

In this second embodiment, the length of tubes 110 can be shortened so that tube-group blocks 130 can be connected together within a given size. Substrates 120 and tubes 110 can be manufactured simultaneously with ease by injection molding or die-casting. This manufacturing method can eliminate the steps of inserting and fixing tubes 110, so that heat exchanger 200 can be available at a lower cost.

In this embodiment, peripheries 190 of substrates 120 are bonded to each other. Peripheries 190 easy to be handled from the outside are bonded together for coupling tube-group blocks 130 together, so that the bonding reliability improves as well as the number of steps decreases. As a result, heat exchanger 200 can be available at a lower cost.

This second embodiment employs multi-hole tubes 110 each of which includes a plurality of flow paths 115. Use of this multi-hole tube allows reducing the number of tubes without reducing the number of flow paths, so that heat exchanger 200 can be manufactured with ease at a lower cost, and yet, since tube-group block 130 is made of inexpensive resin material, heat exchanger 200 can be available at a lower cost.

Peripheries 190 of substrates 120 can be bonded directly to each other by the diffusion welding method, which does not need brazing material or adhesive and allows bonding the substrates free from being melted. As a result, the flow paths in each one of tubes 110 are not clogged, and the number of defectives can be substantially reduced. Heat exchanger 200 can be thus available at a lower cost.

### EXEMPLARY EMBODIMENT 3

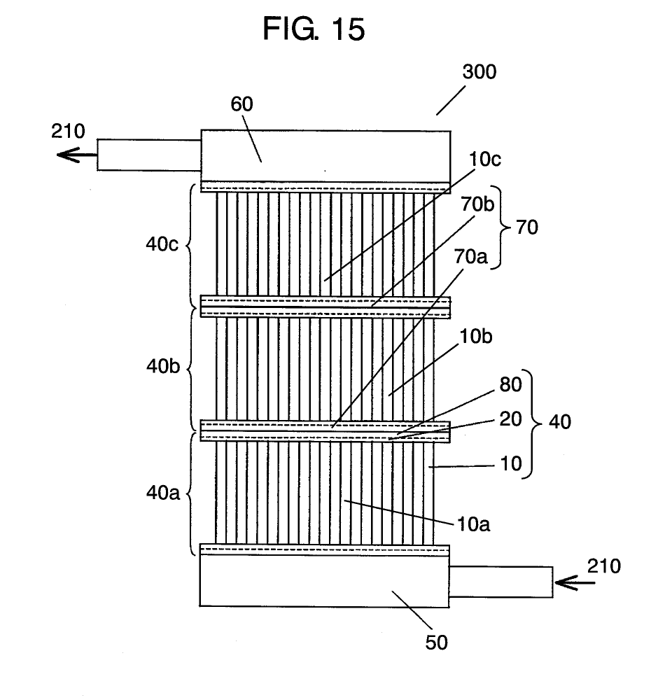

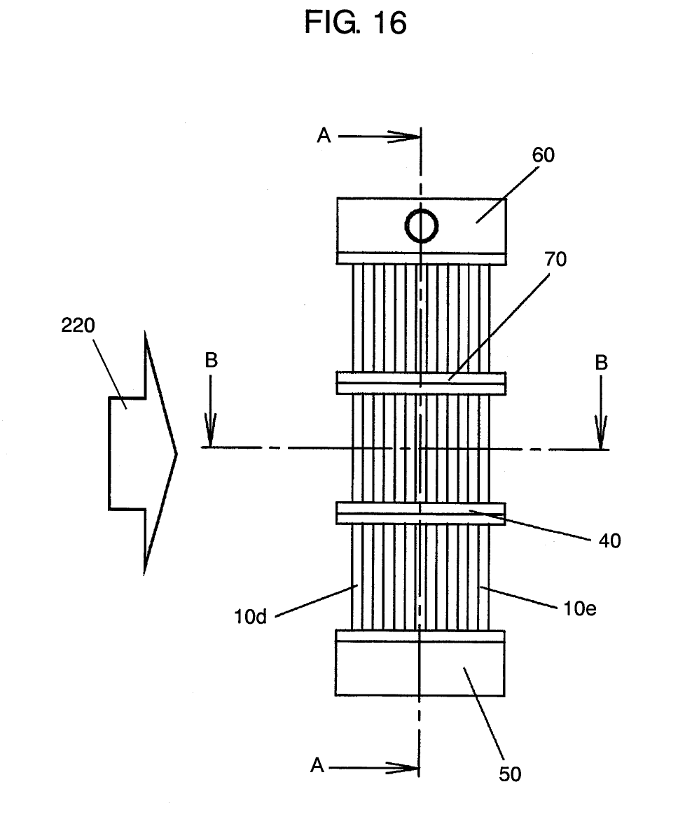

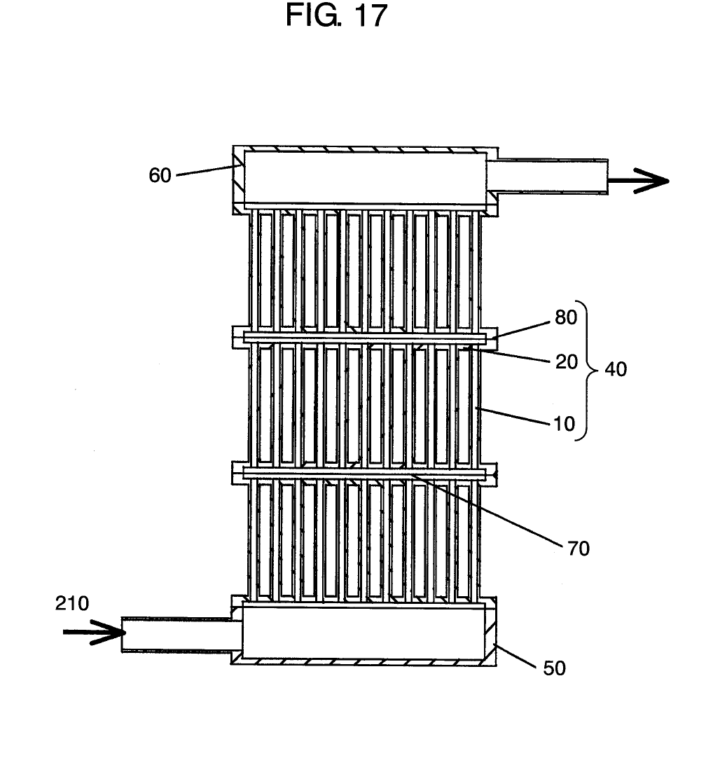

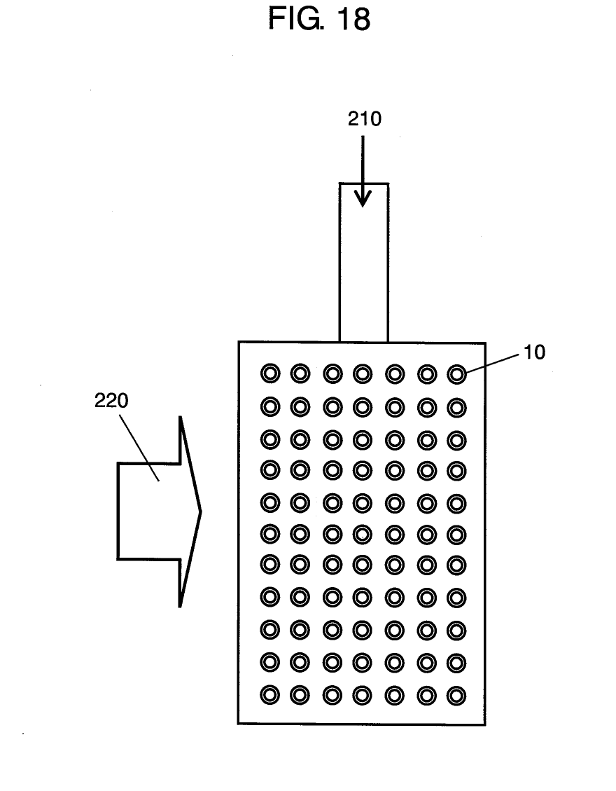

FIG. 15 shows a front view of a heat exchanger in accordance with the third embodiment of the present invention. FIG. 16 shows a lateral view of the heat exchanger, FIG. 17 shows a sectional view cut along line A-A in FIG. 16, and FIG. 18 shows a sectional view cut along line B-B in FIG. 16. Elements similar to those used in the first embodiment have the same reference marks, and the descriptions thereof can be simplified.

In FIG. 15-FIG. 18, heat exchanger 300 includes tube-group blocks 40 formed of tubes 10, substrates 20 and spacers 80. Tube-group blocks 40 are placed one upon another in three layers along the flowing direction of the inner fluid running through tubes 10, and inlet header 50 and outlet header 60 are placed on the lower end and the upper end respectively of the three layers. Spacers 80 are projected stepwise from the peripheries of substrates 20 by a given height and a given width.

Each one of tubes 10 forms a cylindrical tube and includes one flow path through which the inner fluid runs. Tube 10 is not necessarily a cylindrical one, e.g. it can be a tube of which cross section shapes like a rectangle, polygon or ellipse.

Tube-group blocks 40 adjacent to each other are bonded together at spacers 80 placed on the peripheries of substrates 20, and mixer 70 is formed between the bonded substrates 20. In this third embodiment, spacer 80 is provided to each one of blocks 40 bonded together; however, spacer 80 can be provided to at least either one of substrates. In such a case, spacer 80 of first block 40 is bonded to the periphery of substrate 20 of second block 40. The bonding method discussed above bonds tube-group blocks 40 together directly without using brazing material, so that tubes 10 are not clogged with the brazing material supposed to be eluted.

This third embodiment employs the diffusion welding method, which heats the elements up to the temperature not high enough to melt the material of the substrates while applying pressure to them, so that this method differs from a brazing method. The diffusion welding method generates atomic diffusion (interdiffusion) phenomenon, and the bonding is done by using atomic bond. This method eliminates the elution of the substrates, so that tube 10 can be free from being clogged. Use of the diffusion welding, which does not need the brazing material, suppresses defectives such as clogging of tube 10 with the brazing material, so that heat exchanger 300 can be available at a lower cost.

Use of the ultrasonic bonding method obtains the same advantage as discussed above, and other direct bonding methods such as welding or contact bonding method can be used.

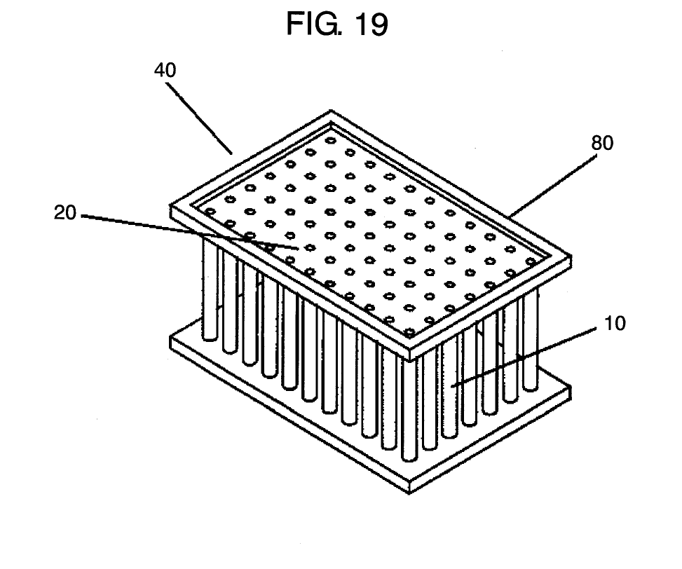

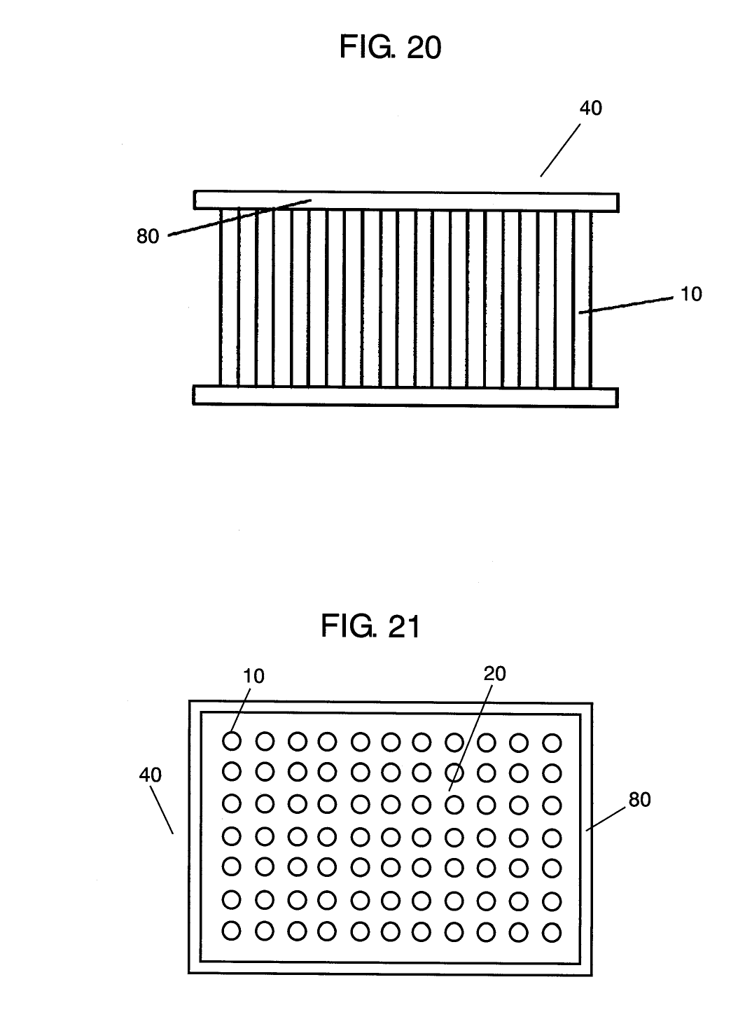

FIG. 19-FIG. 21 illustrate tube-group block 40. FIG. 19 shows a perspective view of heat exchanger 300 in accordance with the third embodiment, FIG. 6 shows a front view of exchanger 300, and FIG. 7 shows a top view of exchanger 300.

Tube-group block 40 is unitarily formed of tubes 10, substrates 20 and spacer 80 by injection molding. Block 40 is preferably made of inexpensive and easy-to-mold resin material. Since tube 10 has a small diameter, and a large number of tubes 10 are used, tube-group block 40 forms a complicated shape. The resin material thus preferably has a low viscosity and high fluidity in molding because the resin should be supplied as deep as up to the respective ends of block 40, particularly when the injection molding method is adopted. Use of such resin material allows reducing the number of defectives, and heat exchanger 300 can be thus available at a lower cost.

When water or antifreeze solution is used as the inner fluid, use of resin material having low water vapor-permeability allows the wall of tube 10 to be thin because the inner fluid hardly permeates through the resin. Thus the material cost can be lowered, and heat exchanger 300 can be available at a lower cost. The resin material is desirably polypropylene (PP) or polyethylene terephthalate (PET), both of which have low water vapor permeability and inexpensive.

Tubes 10 are arranged in check pattern in this embodiment; however it can be arranged in zigzag pattern.

The movement and operation of heat exchanger 300 thus constructed are demonstrated hereinafter. As shown in FIG. 15, heat exchanger 300 comprises three blocks 40a, 40b, and 40c layered in this order from the top to the bottom. Inner fluid 210 flows into inlet header 50, and separates into respective tubes 10a, then passes through tube-group block 40a to mixer 70a where inner fluid 210 is mixed, then mixed inner fluid 210 separates into respective tubes 10b and passes through tube-group block 40b and mixer 70b, and then passes through block 40c and flows outside of heat exchanger 300 via outlet header 60. Outer fluid 220 moves outside respective tubes 10 (including tubes 10a, tubes 10b, and tubes 10c), i.e. between each one of tubes 10, so that the heat is exchanged between inner fluid 210 and outer fluid 220 via tubes 10.

If foreign matters get into inner fluid 210, and one of tubes 10a is clogged with the foreign matter, inner fluid 210 gets around this particular tube 10a, so that this particular tube 10a does not contribute to the heat exchange; however, inner fluid 210 can run through tubes 10b and tubes 10c placed downstream of tubes 10a because inner fluid 210 has passed through other tubes 10a than the particular one clogged with the foreign matter, and has been mixed in mixer 70a, 70b before being separated again. As a result, inner fluid in tubes 10b and tubes 10c can contribute to the heat exchange. Such division of tube-group block 40 into three layers along the flowing direction of inner fluid 210 allows limiting the non-active section (not contribute to the heat exchange due to the clogging) as small as possible, so that this structure can prevent an amount of heat exchange from lowering remarkably.

If a great amount of heat is exchanged, the difference in temperatures becomes smaller between outer fluid 220 and inner fluid 210 running through tubes 10d placed on the upstream side of outer fluid 220 as shown in FIG. 16. In such a case, inner fluid 210 running through tubes 10d placed on the upstream side of outer fluid 220 is mixed at mixer 70a and mixer 70b with inner fluid 210 running through tubes 10e placed on the downstream side of outer fluid 220. Inner fluid 210 in tubes 10d has a smaller temperature difference from outer fluid 220 due to a great amount of heat exchange; however, inner fluid 210 in tubes 10e maintains a great temperature difference from outer fluid 220 due to a small amount of heat exchange. When inner fluid 210 runs through blocks 40b and 40c placed on the downstream side of inner fluid 210, a temperature difference on average between outer fluid 220 and inner fluid 210 becomes greater, so that a great amount of heat can be exchanged.

In this third embodiment, tube-group blocks 40 are overlaid in three layers; however, the number of layers can be two or more than two.

### EXEMPLARY EMBODIMENT 4

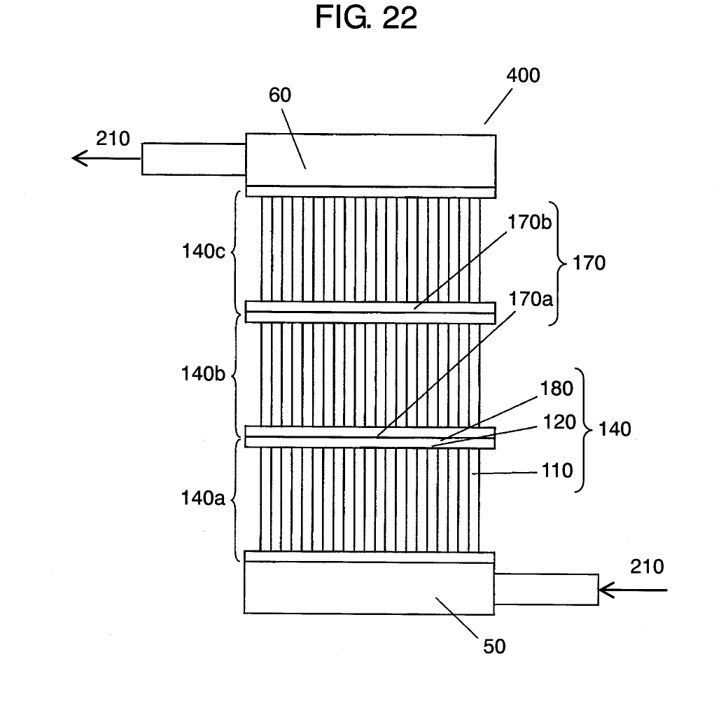

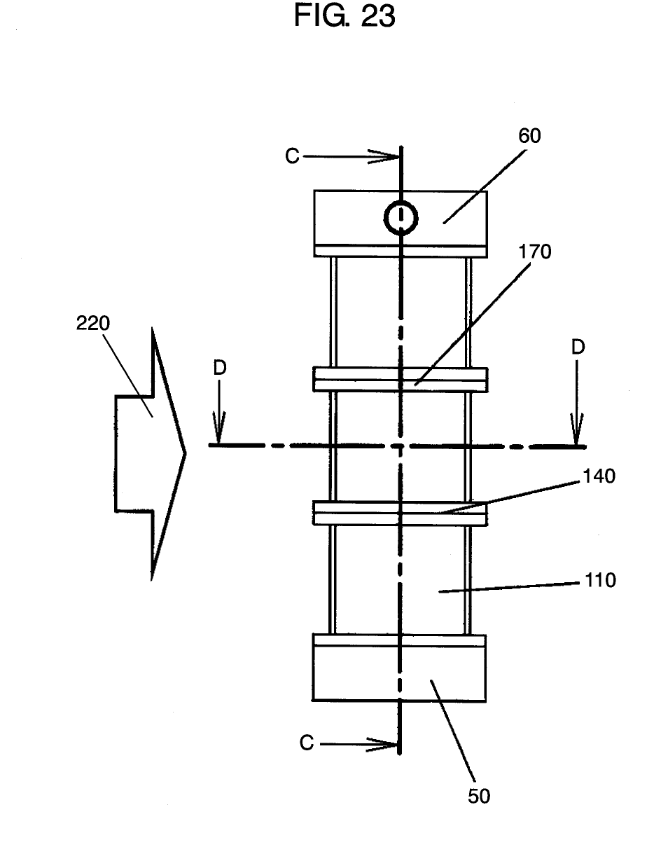

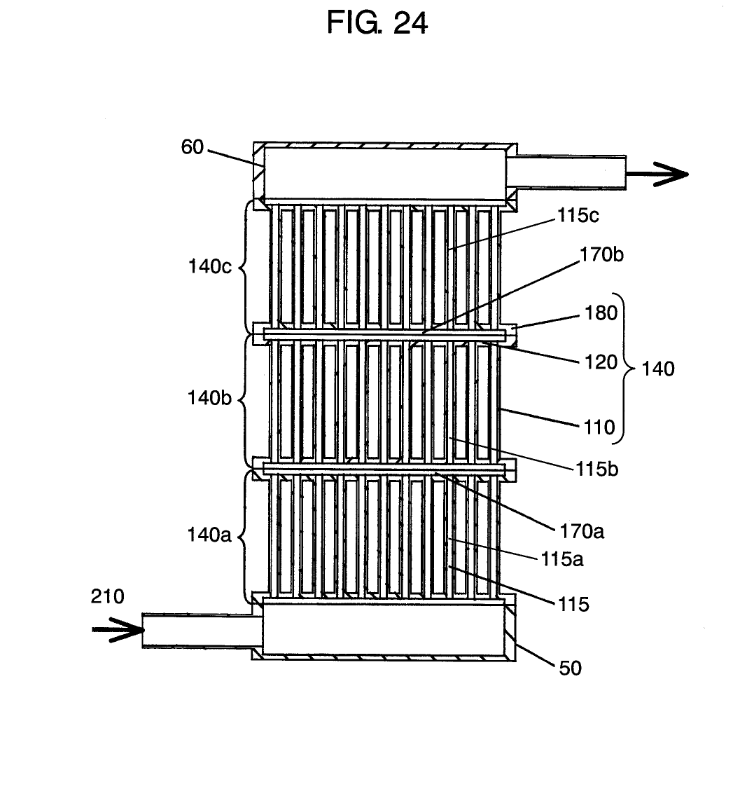

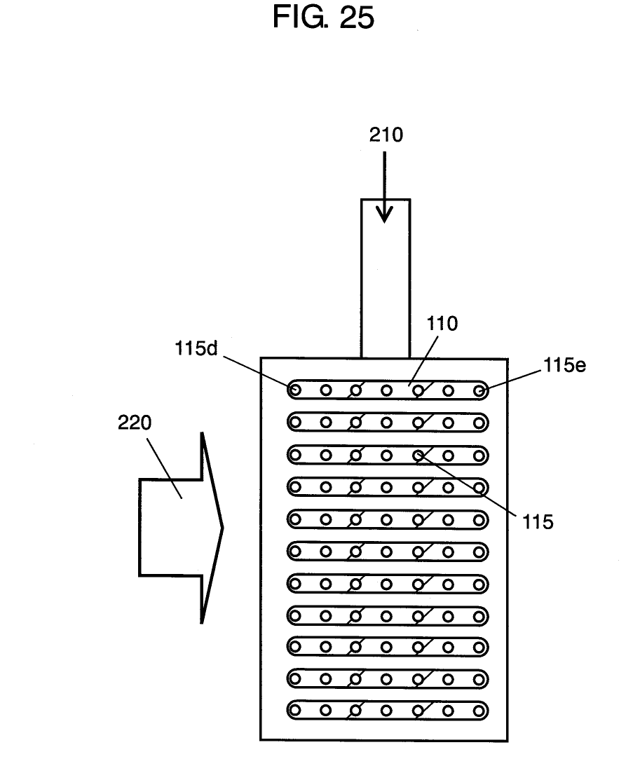

FIG. 22 shows a front view of heat exchanger 400 in accordance with the fourth embodiment of the present invention. FIG. 23 shows a lateral view of heat exchanger 400, FIG. 24 shows a sectional view cut along line C-C in FIG. 23, and FIG. 25 shows a sectional view cut along line D-D in FIG. 23. Elements similar to those used in the first and the second embodiments have the same reference marks, and the descriptions thereof can be simplified.

As shown in FIGS. 22-25, heat exchanger 400 includes tube-group blocks 140 formed of tubes 110, substrates 120 and spacers 180. Tube-group blocks 140 are placed one upon another in three layers along the flowing direction of the inner fluid running through tubes 110, and inlet header 50 and outlet header 60 are placed on the lower end and the upper end of the three layers respectively.

In this fourth embodiment, each one of tubes 110 has a flat sectional view and includes a plurality of flow paths 115 arranged along the long side of the flat shape. Tubes 110 are placed vertically with respect to substrates 120 and arranged in parallel with the long sides of the flat shape respectively at given intervals.

Tube-group blocks 140 adjacent to each other are bonded together at spacers 180 placed on the peripheries of substrates 120, and mixer 170 is formed between the bonded substrates 120. In this fourth embodiment, spacers 180 are provided to each one of blocks 140 bonded together; however, spacer 180 can be provided to at least either one of substrates. In such a case, spacer 180 of first block 140 is bonded to the periphery of substrate 120 of second block 140. The bonding method discussed above bonds tube-group blocks 140 together directly without using brazing material, so that tubes 110 are not clogged with the brazing material supposed to be eluted.

This fourth embodiment employs the diffusion welding, which applies pressure and heat, not high enough for the material of the substrates to be melted, to the substrates simultaneously, thereby generating atomic diffusion (interdiffusion) phenomenon, and the bonding is done by using atomic bond. This method eliminates the elution of the substrates, so that tube 110 can be free from being clogged. Use of the diffusion welding, which does not need the brazing material, suppresses defectives such as clogging of tube 110 with the brazing material, so that heat exchanger 400 can be available at a lower cost.

Use of the ultrasonic bonding method obtains the same advantage as discussed above, and other direct bonding methods such as welding or press-fit bonding method can be used.

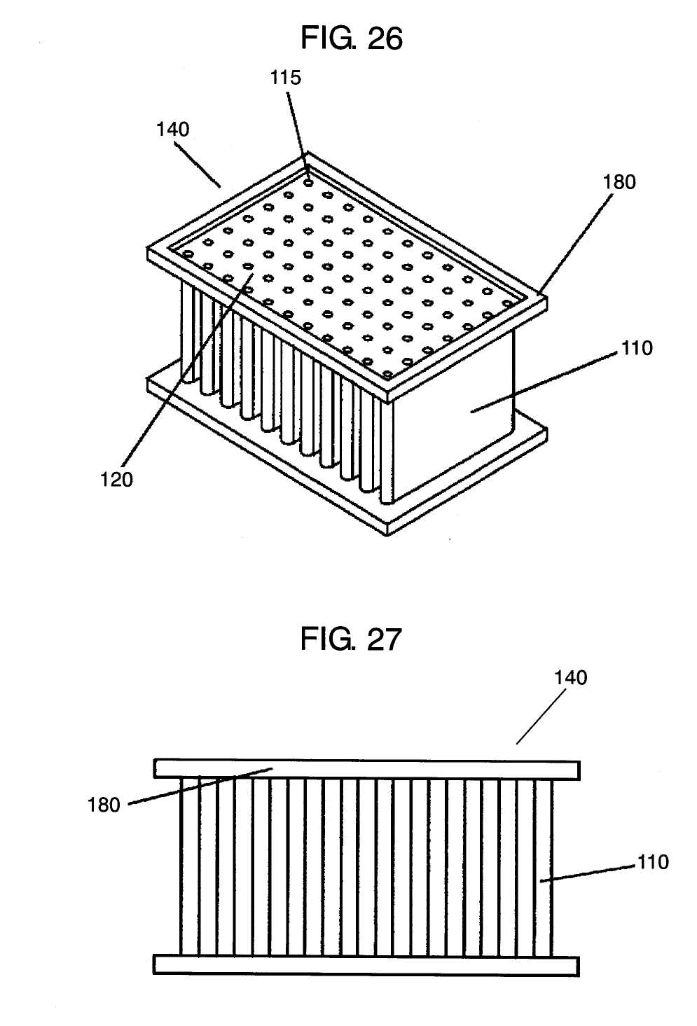

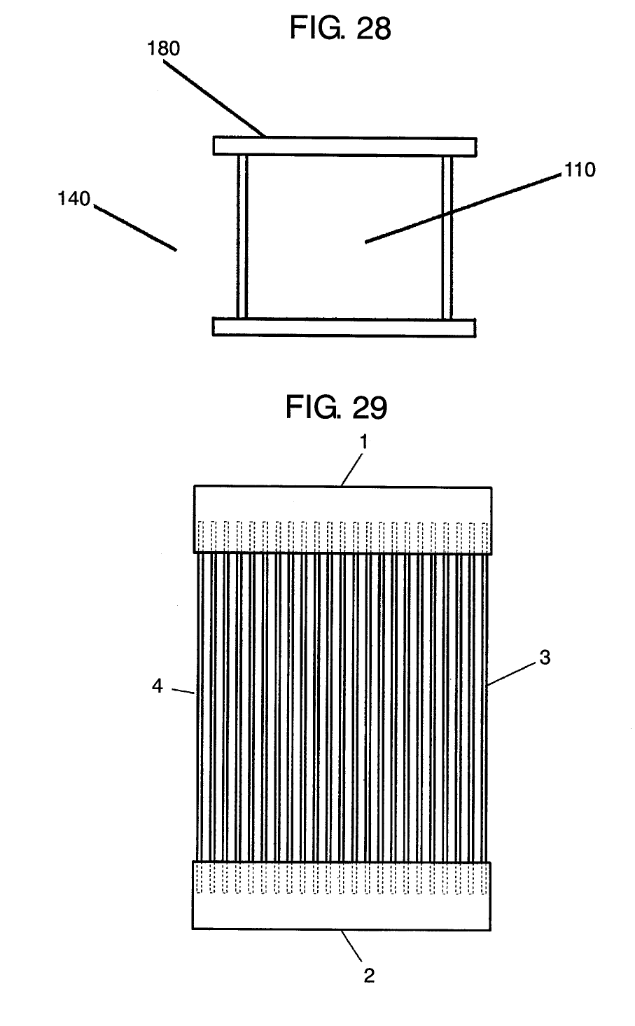

FIG. 26-FIG. 28 illustrate tube-group block 140. FIG. 26 shows a perspective view of heat exchanger 400 in accordance with the fourth embodiment, FIG. 27 shows a front view of exchanger 400, and FIG. 28 shows a lateral view of exchanger 400.

Each one of tube-group blocks 140 is formed by bonding tubes 110, substrates 120 and spacers 180 together. Tube 110 includes a plurality of flow paths 115, so that the number of tubes to be bonded to substrates 120 can be reduced while the number of flow paths is maintained. The number of manufacturing steps can be thus reduced, so that heat exchanger 400 can be available at a lower cost.

The movement and operation of heat exchanger thus constructed are demonstrated hereinafter.

Inner fluid 210 flows into inlet header 50, and separates into each one of flow paths 115 of respective tubes 110, then passes through tube-group block 140a to mixer 170a where the inner fluid is mixed, then the mixed inner fluid 210 separates into respective flow paths 115 of tubes 110 and passes through tube-group block 140b and mixer 170b, and then passes through block 140c and flows outside of heat exchanger 400 via outlet header 60.

Outer fluid 220 moves outside respective tubes 110, i.e. between each one of tubes 110, so that the heat is exchanged between inner fluid 210 and outer fluid 220 via tubes 110. In this case, tubes 110 have a flat sectional view and are arranged such that they are in parallel with the long side of the flat shape respectively at given intervals. This structure does not invite the phenomenon shown in embodiment 3, i.e. round tubes 10 on the downstream side of outer fluid 220 expand the flow paths of outer fluid 220. Outer fluid 220 thus flows at a higher speed, so that the heat transfer rate between outer fluid 220 and tubes 110 increases, which allows increasing an amount of heat exchange.

For instance, if foreign matters get into inner fluid 210, and one of flow paths 115a shown in FIG. 24 is clogged with the foreign matter, inner fluid 210 gets around this particular flow path 116a, so that this particular path 115a does not contribute to the heat exchange; however, inner fluid 210 can run through flow paths 115b and 115c placed downstream of path 115a because inner fluid 210 has passed through other paths 115a than the particular one clogged with the foreign matter, and has been mixed in mixer 170a, 170b before being separated again. As a result, inner fluid 210 in paths 115b and 115c can contribute to the heat exchange. Such division of tube-group block 140 into three layers along the flowing direction of inner fluid 210 allows limiting the non-active section (not contribute to the heat exchange due to the clogging) to an area as small as possible, so that this structure can prevent an amount of heat exchange from lowering conspicuously.

The difference in temperature becomes smaller between outer fluid 220 and inner fluid 210 running through flow paths 115d placed on the upstream side of outer fluid 220 as shown in FIG. 25 because inner fluid 210 exchanges a great amount of heat with outer fluid 220 on the upstream side. On the other hand, inner fluid 210 running through paths 115e on the downstream side of outer fluid 220 maintains the great temperature difference from outer fluid 220. These two kinds of inner fluids 210 are mixed at mixer 170a and mixer 170b, so that when outer fluid 220 runs around blocks 140b and 140c, a temperature difference on average between outer fluid 220 and inner fluid 210 becomes greater, so that a greater amount of heat can be exchanged.

In this fourth embodiment, tube-group blocks 140 are overlaid in three layers; however, the number of layers can be two or more than two. In this embodiment, tubes 110 are bonded to substrates 120; however, they can be unitarily formed as they are done in the third embodiment.

### INDUSTRIAL APPLICABILITY

The heat exchanger of the present invention is obtainable at a lower cost while it maintains excellent heat exchange performance. The heat exchanger thus can be used in refrigerators, air-conditioners, and is applicable to exhaust heat recovery devices.

1. A heat exchanger comprising a tube-group block which includes:
a plurality of substrates with a plurality of through holes; and
a plurality of tubes fixed between the substrates opposite to each other, wherein insides of the tubes communicate with the through holes,
wherein two or more than two tube-group blocks are coupled to each other along an axial direction of the tubes.

2. The heat exchanger of claim 1, wherein the tube-group blocks adjacent to each other are coupled together by bonding the substrates adjacent to each other together at peripheries of the substrates.

3. The heat exchanger of claim 1 further comprising a mixer, wherein the tube-group blocks adjacent are coupled together via the mixer.

4. The heat exchanger of claim 3, wherein the tube-group blocks further include a spacer on peripheries of the substrates opposite to each other, the spacer has a predetermined height and a predetermined width, and the spacer maintains a space between the substrates opposite to each other, wherein the mixer is formed of the substrates opposite to each other and the spacer.

5. The heat exchanger of claim 4, wherein the spacer is formed on the periphery of at least one of the substrates opposite to each other, and forms a step-like protrusion.

6. The heat exchanger as defined in one of claim 1-claim 4, wherein each one of the tubes is a multi-hole tube including a plurality of flow paths.

7. The heat exchanger of claim 6, wherein the multi-hole tube has a flat sectional view, and the flow paths are arranged along a long side of the flat sectional view, and two or more than two multi-hole tubes are arranged generally in parallel with the long side at predetermined intervals and vertically with respect to the substrates.

8. The heat exchanger as defined in one of claim 1-claim 4, wherein the tube-group block is molded and made of resin material.

9. The heat exchanger of claim 8, wherein the tube-group block is unitarily molded.

10. The heat exchanger of claim 8, wherein the resin material has a low viscosity.

11. The heat exchanger of claim 8, wherein the tube-group block is molded and made of resin material having low water vapor permeability.

12. The heat exchanger of claim 8, wherein the resin material is one of polypropylene and polyethylene terephthalate.

13. A method of manufacturing a heat exchanger, the method comprising the steps of:
a first step of coupling a pair of substrates, which have a plurality of through holes and are opposite to each other, together by inserting a plurality of tubes into the through holes for forming a tube-group block;
a second step of coupling two or more than two tube-group blocks together directly by bonding peripheries of the pair of substrates to each other; and
a third step of mounting an inlet header to a first end and mounting an outlet header to a second end of the tube-group blocks coupled together.

14. The manufacturing method of claim 13, wherein the second step includes a step of weld bonding, diffusion welding, or ultrasonic bonding.

15. The manufacturing method of claim 13, wherein the first step includes a step of molding the tube-group blocks with resin, and the second step includes a step of bonding the substrates molded and made of resin together directly.
